(19) United States
(12) Patent Application Publication
(10) Pub. No.: US 2020/0404482 A1
(43) Pub. Date: Dec. 24, 2020

(54) Methods, Network Entities, Network Exposure Entity and Computer Readable Media for Data Delivery Configuration

(71) Applicant: Telefonaktiebolaget LM Ericsson (publ), Stockholm (SE)

(72) Inventor: Wenliang Xu, Shanghai (CN)

(21) Appl. No.: 16/762,962

(22) PCT Filed: Dec. 11, 2017
(86) PCT No.: PCT/CN2017/115433

§ 371 Date: May 11, 2020

(51) Int. Cl. H04W 8/18

(52) U.S. Cl. CPC H04W 8/186; H04W 76/40

(57) ABSTRACT

The present disclosure provides methods in network entities, a method in a network exposure entity, and corresponding network entities and network exposure entity for data delivery configuration. The method in one of the network entities for data delivery configuration comprises: configuring a predefined external group ID which identifies a group of UEs to which data are to be delivered by the network entity and predefined configuration information which indicates a configuration to be applied for the group of UEs that enables a delivery of the data to the group of UEs; and transmitting the predefined external group ID and the configuration information to a network exposure entity. The present disclosure further provides corresponding computer readable medium.

### TECHNICAL FIELD

The present disclosure generally relates to the technical field of telecommunication, and particularly to methods in network entities, a method in a network exposure entity, and corresponding network entities and network exposure entity for data delivery configuration, especially for NIDD (Non-IP data delivery) configuration.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

In order to reduce signaling for a group of UEs which have the same characteristics, a UE grouping concept is introduced in 3GPP. Especially for NIDD, a grouped NIDD for UEs having the same delivery content can significantly reduce signaling load towards SCEF (Service Capability Exposure Function).

Currently, a NIDD terminating service supports group-based delivery as specified in sub-clause 5.5.3 “Group Message Delivery via unicast MT NIDD” of 3GPP TS 23.682 (Rel-15), which is incorporated herein by reference. This means that a third party SCS/AS (Services Capability Server/Application Server) can utilize this service to deliver a message to a group of UEs. This will save network signaling between the SCS/AS and the SCEF to some extent, instead of triggering such an API (Application Programming Interface) for each UE in the group.

However, the group-based delivery as specified in sub-clause 5.5.3 of 3GPP TS 23.682 (Rel-15) does not describe how the group of UEs may be configured, e.g. configured to be able to receive the group-based delivery of downlink NIDD that is specified in said sub-clause 5.5.3 of 3GPP TS 23.682 (Rel-15).

### SUMMARY

Currently, when configuring the UEs in a group of UEs, the third party SCS/AS has to repeat the NIDD configuration for each UE in the group. That is, a prerequisite of using a NIDD service (i.e. NIDD configuration) is still per UE level. It is not efficient to create/update/delete the NIDD configuration for each UE in a group.

Accordingly, at least some objects of the present disclosure are providing technical solutions capable of a grouped operation for the NIDD configuration for at least three entities which are interacting with each other for data delivery configuration, especially NIDD configuration, such as a third party SCS/AS, a SCEF/NEF (Network Exposure Function), and a HSS (Home Subscriber Server), in order to further reduce the signaling load between the SCS/AS and the SCEF/NEF.

According to one aspect of the present disclosure, a method in a network entity for data delivery configuration is provided, comprising:
configuring a predefined external group ID which identifies a group of UEs to which data are to be delivered by the network entity and predefined configuration information which indicates a configuration to be applied for the group of UEs that enables a delivery of the data to the group of UEs; and
transmitting the predefined external group ID and configuration information to a network exposure entity.

In an exemplary embodiment, the predefined external group ID and configuration information are transmitted in a data delivery configuration request message.

In an exemplary embodiment, the data are non-IP data, and the data delivery configuration request message is a Non-IP Data Delivery ‘NIDD’ Configuration Request message.

In an exemplary embodiment, the network entity is a third party SCS/AS, and the network exposure entity is a SCEF entity or a NEF entity.

According to another aspect of the present disclosure, a method in a network exposure entity is provided, comprising:
receiving, from a network entity, a predefined external group ID which identifies a group of UEs to which data are to be delivered by the network entity and predefined configuration information which indicates a configuration to be applied for the group of UEs that enables a delivery of the data to the group of UEs; and
transmitting the external group ID to another network entity.

In an exemplary embodiment, the method further comprises: storing the configuration information indicating the configuration to be applied for the group of UEs that enables the delivery of the data to the group of UEs.

In an exemplary embodiment, the method further comprises:
receiving, from the other network entity, information on IDs of respective UEs in the group; and
storing the information which can be used for group-based delivery of data received from the network entity to the respective UEs in the group.

In an exemplary embodiment, the method further comprises:
transmitting, for each of the respective UEs in the group, the data received from the network entity, based on the stored information.

In an exemplary embodiment, the data are received from the network entity in a data delivery configuration request message.

In an exemplary embodiment, the information comprises:
a list of IMSIs (International Mobile Subscriber Identifications) and a list of MSISDNs (Mobile Station Integrated Services Digital Network Numbers) of the respective UEs in the group; or
a list of IMSIs and a list of external IDs of the respective UEs in the group.

In an exemplary embodiment, the external IDs in the list of external IDs are mapped from the external group ID, and the list of IMSIs and the list of MSISDNs are respectively mapped from the external IDs by the other network entity.

In an exemplary embodiment, the external group ID and the configuration information are received in a data delivery configuration request message, the external group ID is transmitted in a data delivery authorization request message, and the information on IDs of respective UEs in the group is received in a data delivery authorization response message.

In an exemplary embodiment, the data are non-IP data, the data delivery configuration request message is a NIDD configuration request message, the data delivery authorization request message is a NIDD Authorization Request message, and the data delivery authorization response message is a NIDD Authorization Response message.

In an exemplary embodiment, the network exposure entity is a SCEF entity or a NEF entity, the network entity is a third party SCS/AS, and the other network entity is a HSS.

According to another aspect of the present disclosure, a method in a network entity for data delivery configuration is provided, comprising:
receiving, from a network exposure entity, a predefined external group ID which identifies a group of UEs to which data are to be delivered; and
obtaining information on IDs of respective UEs in the group based on the external group ID.

In an exemplary embodiment, the method further comprises:
transmitting the information on IDs of respective UEs in the group to the network exposure entity.

In an exemplary embodiment, obtaining the information on IDs of respective UEs in the group based on the external group ID comprises:
mapping the external group ID to a list of external IDs of respective UEs in the group; and
mapping the external IDs in the list of external IDs respectively to a list of IMSIs and a list of MSISDNs of the respective UEs in the group.

In an exemplary embodiment, the information comprises:
the list of IMSIs and the list of MSISDNs of the respective UEs in the group; or
the list of IMSIs and the list of external IDs of the respective UEs in the group.

In an exemplary embodiment, the external group ID is received in a data delivery authorization request message, and the information on IDs of respective UEs in the group is transmitted in a data delivery authorization response message.

In an exemplary embodiment, the data are non-IP data, the data delivery authorization request message is a NIDD authorization request message, and the data delivery authorization response message is a NIDD Authorization Response message.

In an exemplary embodiment, the network entity is a HSS, and the network exposure entity is a SCEF entity or a NEF entity.

According to another aspect of the present disclosure, a network entity is provided, comprising:
a communication interface arranged for communication,
at least one processor, and
a memory including instructions which, when executed by the at least one processor, cause the network entity to perform operations for data delivery configuration of:
   configuring a predefined external group ID which identifies a group of UEs to which data are to be delivered by the network entity and predefined configuration information which indicates a configuration to be applied for the group of UEs that enables a delivery of the data to the group of UEs; and
   transmitting, via the communication interface, the predefined external group ID and configuration information to a network exposure entity.

In an exemplary embodiment, the predefined external group ID and configuration information are transmitted in a data delivery configuration request message.

In an exemplary embodiment, the data are non-IP data, and the data delivery configuration request message is a NIDD Configuration Request message.

In an exemplary embodiment, the network entity is a third party SCS/AS, and the network exposure entity is a SCEF entity or a NEF entity.

According to another aspect of the present disclosure, a network exposure entity is provided, comprising:
a communication interface arranged for communication, at least one processor, and
a memory including instructions which, when executed by the at least one processor, cause the network exposure entity to perform operations for data delivery configuration of:
   receiving, a predefined external group ID which identifies a group of UEs to which data are to be delivered by a network entity and predefined configuration information which indicates a configuration to be applied for the group of UEs that enables a delivery of the data to the group of UEs, from the network entity via the communication interface; and
   transmitting, via the communication interface, the external group ID to another network entity.

In an exemplary embodiment, the instructions which, when executed by the at least one processor, further cause the network exposure entity to store the configuration information indicating the configuration to be applied for the group of UEs that enables the delivery of the data to the group of UEs.

In an exemplary embodiment, the instructions which, when executed by the at least one processor, further cause the network exposure entity to:
receive, via the communication interface, information on IDs of respective UEs in the group from the other network entity; and
store the information which can be used for group-based delivery of data received from the network entity to the respective UEs in the group.

In an exemplary embodiment, the instructions which, when executed by the at least one processor, further cause the network exposure entity to:
transmit, for each of the respective UEs in the group, the data received from the network entity, based on the stored information.

In an exemplary embodiment, the data are received from the network entity in a data delivery configuration request message.

In an exemplary embodiment, the information comprises:
a list of IMSIs and a list of MSISDNs of the respective UEs in the group; or
a list of IMSIs and a list of external IDs of the respective UEs in the group.

In an exemplary embodiment, the external IDs in the list of external IDs are mapped from the external group ID, and the list of IMSIs and the list of MSISDNs are respectively mapped from the external IDs by the other network entity.

In an exemplary embodiment, the external group ID and the configuration information are received in a data delivery configuration request message, the external group ID is transmitted in a data delivery authorization request message, and the information on IDs of respective UEs in the group is received in a data delivery authorization response message.

In an exemplary embodiment, the data are non-IP data, the data delivery configuration request message is a NIDD configuration request message, the data delivery authorization request message is a NIDD Authorization Request message, and the data delivery authorization response message is a NIDD Authorization Response message.

In an exemplary embodiment, the network exposure entity is a SCEF entity or a NEF entity, the network entity is a third party SCS/AS, and the other network entity is a HSS.

According to another aspect of the present disclosure, a network entity is provided, comprising:
a communication interface arranged for communication,
at least one processor, and
a memory including instructions which, when executed by the at least one processor, cause the network entity to perform operations for data delivery configuration of:
   receiving a predefined external group ID, which identifies a group of UEs to which data are to be delivered, from a network exposure entity via the communication interface; and
   obtaining information on IDs of respective UEs in the group based on the external group ID.

In an exemplary embodiment, the instructions which, when executed by the at least one processor, further cause the network entity to:
transmit the information on IDs of respective UEs in the group to the network exposure entity.

In an exemplary embodiment, the instructions which, when executed by the at least one processor, cause the network entity to obtain the information on IDs of respective UEs in the group based on the external group ID further cause the network entity to:
map the external group ID to a list of external IDs of respective UEs in the group; and
map the external IDs in the list of external IDs respectively to a list of IMSIs and a list of MSISDNs of the respective UEs in the group.

In an exemplary embodiment, the information comprises:
the list of IMSIs and the list of MSISDNs of the respective UEs in the group; or
the list of IMSIs and the list of external IDs of the respective UEs in the group.

In an exemplary embodiment, the external group ID is received in a data delivery authorization request message, and the information on IDs of respective UEs in the group is transmitted in a data delivery authorization response message.

In an exemplary embodiment, the data are non-IP data, the data delivery authorization request message is a NIDD authorization request message, and the data delivery authorization response message is a NIDD Authorization Response message.

In an exemplary embodiment, the network entity is a HSS, and the network exposure entity is a SCEF entity or a NEF entity.

According to another aspect of the present disclosure, a computer readable medium which stores computer program comprising instructions which, when executed on at least one processor, cause the at least one processor to perform the methods for data delivery configuration as discussed previously.

According to the above technical solutions of the present disclosure, the external group ID which identifies the group of UEs to which data are to be delivered is introduced in the data delivery configuration request message transmitted from the third party network entity to the network exposure entity, which in turn forwards the external group ID to another network entity; then, the other network entity obtains the information on the IDs of respective UEs in the group based on the external group ID, and transmits the information on the IDs of respective UEs in the group to the network exposure entity, so that the network exposure entity may transmit, for each of the respective UEs in the group, the data received from the network entity based on the information, i.e., implementing group-based data delivery based on the group-based data delivery configuration, which may further reduce the signaling load between the network entity and the network exposure entity.

### BRIEF DESCRIPTION OF THE DRAWINGS

The objects, advantages and characteristics of the present disclosure will be more apparent, according to descriptions of preferred embodiments in connection with the drawings, on which:

FIG. 1 illustratively a flowchart of a method at a first network entity, such as SCS/AS, for data delivery configuration according to an exemplary embodiment of the present disclosure;

FIG. 2 illustratively shows a flowchart of a method at a network exposure entity, such as SCEF/NEF, for data delivery configuration according to an exemplary embodiment of the present disclosure;

FIG. 3 illustratively shows a flowchart of a method at a second network entity, such as HSS, for data delivery configuration according to an exemplary embodiment of the present disclosure;

FIG. 4 illustratively shows an exemplary group data delivery configuration procedure according to an exemplary embodiment of the present disclosure;

FIG. 5 illustratively shows a schematic structure diagram of a first network entity, such as SCS/AS, according to an exemplary embodiment of the present disclosure;

FIG. 6 illustratively shows a schematic structure diagram of a first network entity, such as SCS/AS, according to another exemplary embodiment of the present disclosure;

FIG. 7 illustratively shows a schematic structure diagram of a network exposure entity, such as SCEF/NEF, according to an exemplary embodiment of the present disclosure;

FIG. 8 illustratively shows a schematic structure diagram of a network exposure entity, such as SCEF/NEF, according to another exemplary embodiment of the present disclosure;

FIG. 9 illustratively shows a schematic structure diagram of a second network entity, such as HSS, according to an exemplary embodiment of the present disclosure; and

FIG. 10 illustratively shows a schematic structure diagram of a second network entity, such as HSS, according to another exemplary embodiment of the present disclosure.

It should be noted that throughout the drawings, same or similar reference numbers are used for indicating same or similar elements; various parts in the drawings are not drawn to scale, but only for an illustrative purpose, and thus should not be understood as any limitations and constraints on the scope of the present disclosure.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in references as follows, which are all incorporated herein by reference:
1) 3GPP TS 23.682 Release 15,
2) 3GPP TS 29.336 Release 15, and
3) 3GPP TS 29.122 Release 15.

References in the specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be liming of exemplary embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

The techniques described herein may be used for various wireless communication networks such as CDMA, TDMA, FDMA, OFDMA, SC-FDMA, LTE and other networks developed in the future. The terms “network” and “system” are often used interchangeably. For illustration only, certain aspects of the techniques are described below for the next, i.e. the 5^{th} generation of wireless communication network. However, it will be appreciated by the skilled in the art that the techniques described herein may also be used for other wireless networks such as LTE and corresponding radio technologies mentioned herein as well as wireless networks and radio technologies proposed in the future.

As used herein, the term “UE” may be, by way of example and not limitation, a SS (Subscriber Station), a Portable Subscriber Station, a MS (Mobile Station), a MT (Mobile Terminal) or an AT (Access Terminal). The UE may include, but not limited to, mobile phones, cellular phones, smart phones, or personal digital assistants (PDAs), portable computers, image capture terminal devices such as digital cameras, gaming terminal devices, music storage and playback appliances, wearable terminal devices, vehicle-mounted wireless terminal devices and the like. In the following description, the terms “UE”, “terminal device”, “mobile terminal” and “user equipment” may be used interchangeably.

For clarify, a “first” network entity and a “second” network entity are used to distinguish two network entities which are interacting with the network exposure entity from a right side and from a left side respectively throughout the specification.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments.

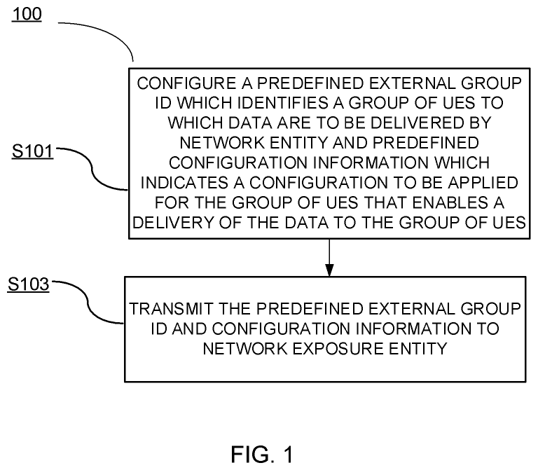

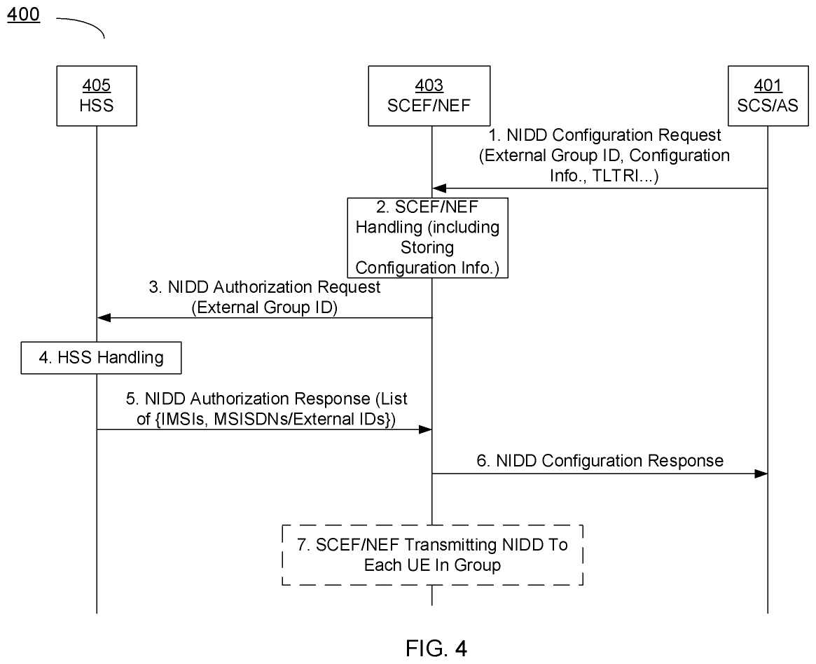

Hereinafter, a method at a first network entity according to an exemplary embodiment of the present disclosure will be described with reference to FIGS. 1 and 4.

FIG. 1 illustratively shows a flowchart of a method 100 for group-based data delivery configuration according to an exemplary embodiment of the present disclosure, which is performed at a first network entity, such as SCEF or NEF (e.g. SCS/AS 401 as shown in FIG. 4). FIG. 4 illustratively shows an exemplary group data delivery configuration procedure according to an exemplary embodiment of the present disclosure, which will be described in detail later.

As shown in FIG. 1, the method 100 for group-based data delivery configuration may include Steps S101 and S103.

In Step S101, the first network entity may configure a predefined external group ID which identifies a group of UEs to which data are to be delivered by the first network entity. The first network entity may also configure predefined configuration information (including PDN connection establishment option, Reliable Data Service Configuration, Non-IP data, etc.) which indicates a configuration to be applied for the group of UEs that enables a delivery of the data to the group of UEs. Preferably, the configuration information applies equally (e.g. in the same way) to each UE in the group of UEs.

The external group ID may be predefined in the first network entity and a second network entity, such as HSS (e.g. HSS 405 in FIG. 4), based on e.g. service agreements between the first network entity and the second network entity.

Grouping of the UEs may be performed based on e.g. traffic characteristics, requirements etc., so that the UEs, e.g. CloT (Consumer Internet of Things) devices, such as sensors, cameras, having the same characteristics can be grouped in one group.

The configuration information may also be predefined in the first network entity and the second network entity, based on e.g. the service agreements between the first network entity and the second network entity. Moreover, the configuration information may e.g. be applied for the identified group of UEs by a control plane network entity, e.g. by a Mobility Management Entity (MME) or similar that has in turn obtained the configuration information from the network exposure entity that originally received the configuration information from the first network entity. The configuration information may e.g. be applied when establishing a connection with the UEs in the identified group of UEs, e.g. in an attach procedure or similar for establishing a NIDD communication. The configuration may also be used by the network exposure entity to decide how to deliver an MT NIDD in case of absent NIDD connection between the network exposure entity and the control plane network entity, e.g. MME.

Then in Step S103, the first network entity may transmit the predefined external group ID and configuration information to a network exposure entity, such as SCEF or NEF (e.g. SCEF/NEF 403 in FIG. 4).

The predefined external group ID and configuration information may be transmitted in a data delivery configuration request message which is sent from the first network entity to the network exposure entity.

In an embodiment, the data may be non-IP data, and the data delivery configuration request message may be a NIDD Configuration Request message sent from the first network entity to the network exposure entity (e.g. NIDD Configuration Request from SCS/AS 401 to SCEF/NEF 403 in Process 1 of FIG. 4).

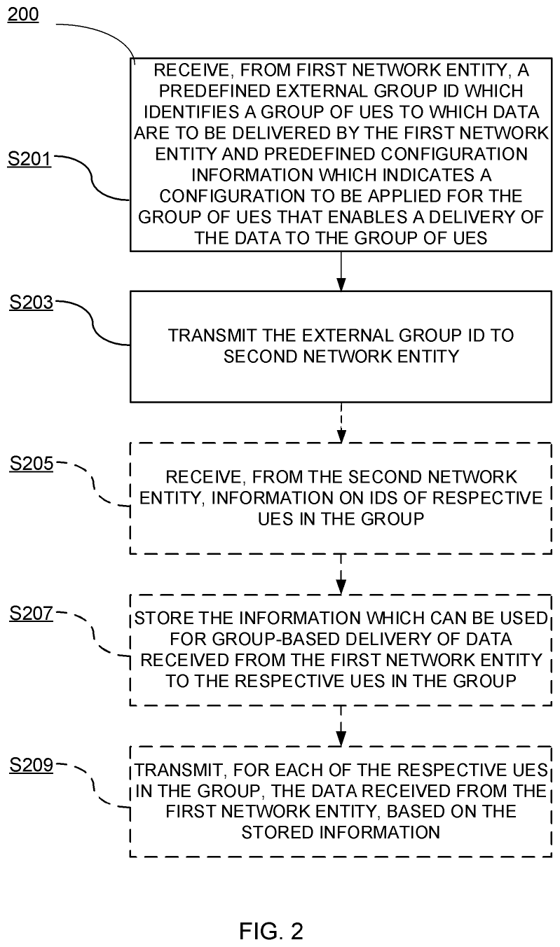

Hereinafter, a method at a network exposure entity according to an exemplary embodiment of the present disclosure will be described with reference to FIGS. 2 and 4.

FIG. 2 illustratively shows a flowchart of a method 200 for group-based data delivery configuration according to an exemplary embodiment of the present disclosure, which is performed at a network exposure entity, such as SCEF or NEF (e.g. SCEF/NEF 403 as shown in FIG. 4).

As shown in FIG. 2, the method 200 for group-based data delivery configuration may include Steps S201 and S203.

In Step S201, the network exposure entity may receive, from a first network entity, such as SCS/AS (e.g. SCS/AS 401 as shown in FIG. 4), a predefined external group ID which identifies a group of UEs to which data are to be delivered by the first network entity. The network exposure entity may also receive, from the first network entity, predefined configuration information which indicates a configuration to be applied for the group of UEs that enables a delivery of the data to the group of UEs.

As described in Step S103, the external group ID may be predefined in the first network entity and a second network entity, such as HSS (e.g. HSS 405 in FIG. 4), based on e.g. service agreements between the first network entity and the second network entity. Grouping of the UEs may be performed based on e.g. traffic characteristics, requirements etc., so that the UEs, e.g. CloT devices, such as sensors, cameras, having the same characteristics can be grouped in one group.

The configuration information may also be predefined in the first network entity and the second network entity, based on e.g. the service agreements between the first network entity and the second network entity.

the external group ID and the configuration information may be received in a data delivery configuration request message which is sent from the first network entity to the network exposure entity.

In an embodiment, the data may be non-IP data, and the data delivery configuration request message may be a NIDD Configuration Request message sent from the first network entity to the network exposure entity (e.g. NIDD Configuration Request from SCS/AS 401 to SCEF/NEF 403 in Process 1 of FIG. 4).

The network exposure entity may store the configuration information indicating the configuration to be applied for the group of UEs that enables the delivery of the data to the group of UEs, so as to associate the configuration information with the external group ID and use it for further MT NIDD delivery.

Then in Step S203, the network exposure entity may transmit the external group ID to a second network entity, such as HSS (e.g. HSS 405 as shown in FIG. 4).

The external group ID may be transmitted in a data delivery authorization request message which is sent from the network exposure entity to the second network entity.

In an embodiment, the data may be non-IP data, and the data delivery authorization request message may be a NIDD Authorization Request message sent from the network exposure entity to the second network entity (e.g. NIDD Authorization Request from SCEF/NEF 403 to HSS 405 in Process 3 of FIG. 4).

Next, the method 200 may further comprise Steps S205 and S207 as shown in dashed line blocks in FIG. 2, after the network exposure entity transmits the external group ID to the second network entity which may in turn processes the received external group ID to obtain and transmit to the network exposure entity information on IDs of respective UEs in the group.

In Step S205, the network exposure entity may receive the information on IDs of respective UEs in the group from the second network entity.

In an embodiment, the information on IDs of respective UEs in the group may be received in a data delivery authorization response message which is sent from the second network entity to the network exposure entity.

In an embodiment, the data may be non-IP data, and the data delivery authorization response message is a NIDD Authorization Response message sent from the second network entity to the network exposure entity (e.g. NIDD Authorization Response from HSS 405 to SCEF/NEF 403 in Process 5 of FIG. 4).

In an embodiment, the information on IDs of respective UEs in the group may include:
a list of IMSIs and a list of MSISDNs of the respective UEs in the group; or
a list of IMSIs and a list of external IDs of the respective UEs in the group.

The external IDs in the list of external IDs may be mapped from the external group ID by the second network entity. The list of IMSIs and the list of MSISDNs may be respectively mapped from the external IDs by the second network entity.

Then in Step S207, the network exposure entity may store the information on IDs of respective UEs in the group. Such information may be used for group-based delivery of data received from the first network entity to the respective UEs in the group.

The network exposure entity may also transmit a data delivery configuration response message to the first network entity.

In an embodiment, the data may be non-IP data, and the data delivery configuration request message may be a NIDD Configuration Response message sent from the first network entity to the network exposure entity (e.g. NIDD Configuration Response from SCEF/NEF 403 to SCS/AS 401 in Process 6 of FIG. 4).

When there are data to be delivered from the network exposure entity to the respective UEs in the group, the method 200 may further comprise Step S209 as shown in dashed line blocks in FIG. 2, in which the network exposure entity may transmit, for each of the respective UEs in the group, the data received from the first network entity, based on the stored information (e.g. in Process 7 in FIG. 4).

In an embodiment, the data may be received by the network exposure entity from the first network entity in a data delivery configuration request message (e.g., NIDD

Configuration Request from SCS/AS 401 to SCEF/NEF 403 in Process 1 of FIG. 4). In this case, the network exposure entity may transmit the data to the respective UEs in the group, only after a PDN connection to the network exposure entity is established as defined in clause 5.13.1.2 of 3GPP TS 23.682, which is incorporated herein by reference.

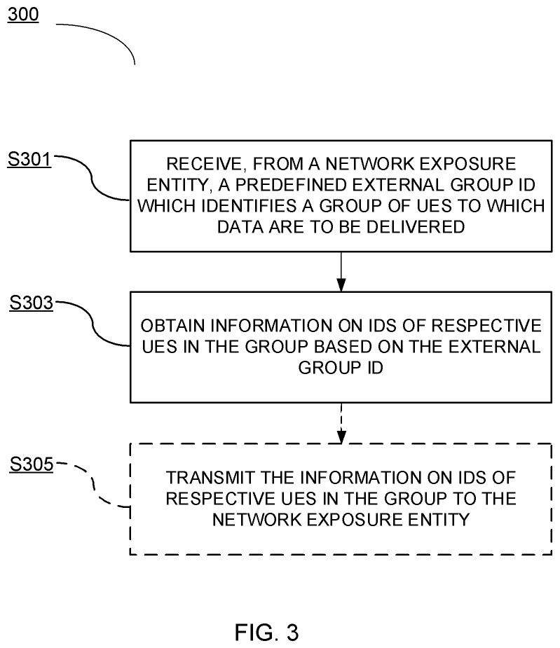

Hereinafter, a method at a second network entity according to an exemplary embodiment of the present disclosure will be described with reference to FIGS. 3 and 4.

FIG. 3 illustratively shows a flowchart of a method 300 for group-based data delivery configuration according to an exemplary embodiment of the present disclosure, which is performed at a second network entity, such as HSS (e.g. HSS 405 as shown in FIG. 4).

As shown in FIG. 3, the method 300 for group-based data delivery configuration may include Steps S301 and S303.

In Step S301, the second network entity may receive, from a network exposure entity, such as SCEF or NEF (e.g. SCEF/NEF 403 as shown in FIG. 4), a predefined external group ID which identifies a group of UEs to which data are to be delivered.

As previously described, the external group ID may be predefined in the first network entity, such as SCS/AS (e.g. SCS/AS 401 in FIG. 4) and a second network entity, based on e.g. service agreements between the first network entity and the second network entity. Grouping of the UEs may be performed based on e.g. traffic characteristics, requirements etc., so that the UEs, e.g. CloT devices, such as sensors, cameras, having the same characteristics can be grouped in one group.

As described in Step S203, the external group ID may be received in a data delivery authorization request message which is sent from the network exposure entity to the second network entity.

In an embodiment, the data may be non-IP data, and the data delivery authorization request message may be a NIDD Authorization Request message sent from the network exposure entity to the second network entity (e.g. NIDD Authorization Request from SCEF/NEF 403 to HSS 405 in Process 3 of FIG. 4).

Then in Step S303, the second network entity may obtain information on IDs of respective UEs in the group based on the external group ID (e.g. in Process 4 of FIG. 4).

In an embodiment, the second network entity may examine the received data delivery authorization request message, e.g., with regard to existence of the external group ID; and map the external group ID to a list of external IDs of respective UEs in the group, e.g. according to its knowledge on correspondence between the external group ID and list of external IDs of respective UEs in the group predefined and stored in its database, and map the external IDs in the list of external IDs respectively to a list of IMSIs and a list of MSISDNs of the respective UEs in the group.

Thus, the information on IDs of respective UEs in the group may include:
the list of IMSIs and the list of MSISDNs of the respective UEs in the group; or
the list of IMSIs and the list of external IDs of the respective UEs in the group.

Next, the method 300 may further include Step S305, in which the second network entity may transmit the information on IDs of respective UEs in the group to the network exposure entity.

As described in Step S205, the information on IDs of respective UEs in the group may be transmitted in a data delivery authorization response message which is sent from the second network entity to the network exposure entity.

In an embodiment, the data may be non-IP data, and the data delivery authorization response message is a NIDD Authorization Response message sent from the second network entity to the network exposure entity (e.g. NIDD Authorization Response from HSS 405 to SCEF/NEF 403 in Process 5 of FIG. 4).

Hereinafter, a complete group data delivery configuration procedure according to an exemplary embodiment of the present disclosure will be described in FIG. 4. In the example of FIG. 4, three network entities are particularly shown as e.g., SCS/AS 401, SCEF/NEF 403 and HSS 405, which are interacting with each other for data delivery configuration, especially NIDD configuration.

It should be understood that although FIG. 4 shows particular entities, such as SCS/AS 401, SCEF/NEF 403 and HSS 405, as examples, they are not intended to be liming of the exemplary embodiments in any way. Instead, the exemplary group data delivery configuration procedure as shown in FIG. 4 may be implemented by other network entities as appropriate, if necessary.

The exemplary group data delivery configuration procedure 400 in FIG. 4 may include Processes 1-6 as follows.

Firstly, SCS/AS 401 may configure a predefined external group ID which identifies a group of UEs to which data are to be delivered by SCS/AS 401. SCS/AS 401 may also configure predefined configuration information (including PDN connection establishment option, Reliable Data Service Configuration, Non-IP data, etc.) which indicates a configuration to be applied for the group of UEs that enables a delivery of the data to the group of UEs.

The external group ID may be predefined in the first network entity and a second network entity, such as HSS (e.g. HSS 405 in FIG. 4), based on e.g. service agreements between the first network entity and the second network entity. Grouping of the UEs may be performed based on e.g. traffic characteristics, requirements etc., so that the UEs, e.g. CloT devices, such as sensors, cameras, having the same characteristics can be grouped in one group.

The configuration information may also be predefined in the first network entity and the second network entity, based on e.g. the service agreements between the first network entity and the second network entity.

In Process 1, SCS/AS 401 may transmit the predefined external group ID and configuration information in a NIDD Configuration Request to SCEF/NEF 403.

Besides the external group ID, the NIDD Configuration Request may include External Identifier or MSISDN, SCS/AS Identifier, TTRI (T8 Transaction Reference ID), TLTRI (T8 Long Term Transaction Reference ID), configuration information (including Requested Action, a PDN Connection Establishment Option, Reliable Data Service Configuration etc.), as described in detail in clause 5.13.2 of 3GPP TS 23.682, descriptions thereof will be omitted here for simplicity.

In Process 2, SCEF/NEF 403 processes the received NIDD Configuration Request including the external group ID, configuration information, after receiving the NIDD Configuration Request from SCS/AS 401.

SCEF/NEF 403 may store the configuration information indicating the configuration to be applied for the group of UEs that enables the delivery of the data to the group of UEs, so as to associate the configuration information with the external group ID and use it for further MT NIDD delivery.

Then in Process 3, SCEF/NEF 403 transmits the external group ID in a NIDD Authorization Request to HSS 405.

In Process 4, HSS 405 processes the received NIDD Authorization Request including the external group ID, after receiving the NIDD Authorization Request from SCEF/NEF 403.

In an embodiment, HSS 405 may examine the received NIDD Authorization Request, e.g., with regard to existence of the external group ID; and map the external group ID to a list of external IDs of respective UEs in the group, e.g. according to its knowledge on correspondence between the external group ID and list of external IDs of respective UEs in the group predefined and stored in its database, and map the external IDs in the list of external IDs respectively to a list of IMSIs and a list of MSISDNs of the respective UEs in the group.

Thus, the information on IDs of respective UEs in the group may include:
the list of IMSIs and the list of MSISDNs of the respective UEs in the group; or
the list of IMSIs and the list of external IDs of the respective UEs in the group.

Then in Process 5, HSS 405 transmits the external group ID in a NIDD Authorization Response to SCEF/NEF 403. In particular, the NIDD Authorization Response may include: the list of IMSIs and the list of MSISDNs of the respective UEs in the group; or the list of IMSIs and the list of external IDs of the respective UEs in the group.

After SCEF/NEF 403 receives the information on IDs of respective UEs in the group from HSS 405, SCEF/NEF 403 stores the information on IDs of respective UEs in the group. Such information may be used for group-based delivery of data received from SCS/AS 401 to the respective UEs in the group.

Next in Process 6, SCEF/NEF 403 transmits a NIDD Configuration Response to SCS/AS 401.

So far, the group-based NIDD configuration procedure has been completed.

When there are data to be delivered from SCEF/NEF 403 to the respective UEs in the group, SCEF/NEF 403 may transmit, for each of the respective UEs in the group, the data received from SCS/AS 401, based on the stored information, as illustrated in Process 7 shown in a dashed line block in FIG. 4.

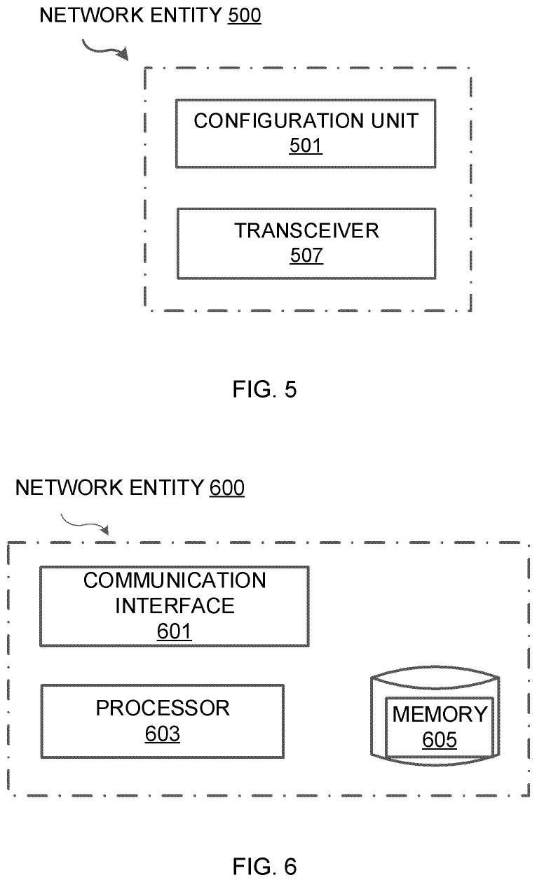

Hereinafter, a structure of a first network entity will be described with reference to FIG. 5. FIG. 5 illustratively shows a schematic structure diagram of a network entity 500 (referring to the first network entity, such as SCS/AS, e.g. SCS/AS 401 as shown in FIG. 4, as described previously) according to an exemplary embodiment of the present disclosure. The network entity 500 in FIG. 5 may perform the method 100 for group-based data delivery configuration described previously with reference to FIG. 1. Accordingly, some detailed description on the network entity 500 may refer to the corresponding description of the method 100 for group-based data delivery configuration as previously discussed.

As shown in FIG. 5, the network entity 500 may include a configuration unit 501 and a transceiver 503. As will be understood by the skilled in the art, common components in the network entity 500 are omitted in FIG. 5 for not obscuring the idea of the present disclosure.

The configuration unit 501 of the network entity 500 may be configured to configure, in Step S101, a predefined external group ID which identifies a group of UEs to which data are to be delivered by the network entity 500. The configuration unit 501 of the network entity 500 may also be configured to configure predefined configuration information (including PDN connection establishment option, Reliable Data Service Configuration, Non-IP data, etc.) which indicates a configuration to be applied for the group of UEs that enables a delivery of the data to the group of UEs. Preferably, the configuration information applies equally to each UE in the group of UEs.

The external group ID may be predefined in the first network entity and a second network entity, such as HSS (e.g. HSS 405 in FIG. 4), based on e.g. service agreements between the first network entity and the second network entity. Grouping of the UEs may be performed based on e.g. traffic characteristics, requirements etc., so that the UEs, e.g. CloT devices, such as sensors, cameras, having the same characteristics can be grouped in one group.

The configuration information may also be predefined in the first network entity and the second network entity, based on e.g. the service agreements between the first network entity and the second network entity.

The transceiver 503 of the network entity 500 may be configured to transmit, in Step S103, the predefined external group ID and configuration information to a network exposure entity, such as SCEF or NEF (e.g. SCEF/NEF 403 in FIG. 4).

The predefined external group ID and configuration information may be transmitted by the transceiver 503 in a data delivery configuration request message to the network exposure entity.

In an embodiment, the data may be non-IP data, and the data delivery configuration request message may be a NIDD Configuration Request message sent from the network entity 500 to the network exposure entity (e.g. NIDD Configuration Request from SCS/AS 401 to SCEF/NEF 403 in Process 1 of FIG. 4).

Hereinafter, another structure of a first network entity will be described with reference to FIG. 6. FIG. 6 illustratively shows a schematic structure diagram of a network entity 600 (referring to the first network entity, such as SCS/AS, e.g. SCS/AS 401 as shown in FIG. 4, as described previously) according to an exemplary embodiment of the present disclosure. The network entity 600 in FIG. 6 may perform the method 100 for group-based data delivery configuration described previously with reference to FIG. 1. Accordingly, some detailed description on the network entity 600 may refer to the corresponding description of the method 100 for group-based data delivery configuration as previously discussed.

As shown in FIG. 6, the network entity 600 may include at least one controller or processor 603 including e.g., any suitable Central Processing Unit, CPU, microcontroller, Digital Signal Processor, DSP, etc., capable of executing computer program instructions. The computer program instructions may be stored in a memory 605. The memory 605 may be any combination of a RAM (Random Access Memory) and a ROM (Read Only Memory). The memory may also comprise persistent storage, which, for example, can be any single one or combination of magnetic memory, optical memory, or solid state memory or even remotely mounted memory. The exemplary network entity 600 further comprises a communication interface 601 arranged for communication.

The instructions, when loaded from the memory 605 and executed by the at least one processor 603, may cause the network entity 600 to perform the method 100 as previously described.

In particular, the instructions, when loaded from the memory 605 and executed by the at least one processor 603, may cause the network entity 600 to configure, in step S101, a predefined external group ID which identifies a group of UEs to which data are to be delivered by the network entity and predefined configuration information (including PDN connection establishment option, Reliable Data Service Configuration, Non-IP data, etc.) which indicates a configuration to be applied for the group of UEs that enables a delivery of the data to the group of UEs. Preferably, the configuration information applies equally to each UE in the group of UEs.

The external group ID may be predefined in the first network entity and a second network entity, such as HSS (e.g. HSS 405 in FIG. 4), based on e.g. service agreements between the first network entity and the second network entity. Grouping of the UEs may be performed based on e.g. traffic characteristics, requirements etc., so that the UEs, e.g. CloT devices, such as sensors, cameras, having the same characteristics can be grouped in one group.

The configuration information may also be predefined in the first network entity and the second network entity, based on e.g. the service agreements between the first network entity and the second network entity.

The instructions, when loaded from the memory 605 and executed by the at least one processor 603, may cause the network entity 600 to transmit, in step S103, the predefined external group ID and configuration information to a network exposure entity, such as SCEF or NEF (e.g. SCEF/NEF 403 in FIG. 4) via the communication interface 601.

The predefined external group ID and configuration information may be transmitted in a data delivery configuration request message to the network exposure entity.

In an embodiment, the data may be non-IP data, and the data delivery configuration request message may be a NIDD Configuration Request message sent from the network entity 600 to the network exposure entity (e.g. NIDD Configuration Request from SCS/AS 401 to SCEF/NEF 403 in Process 1 of FIG. 4).

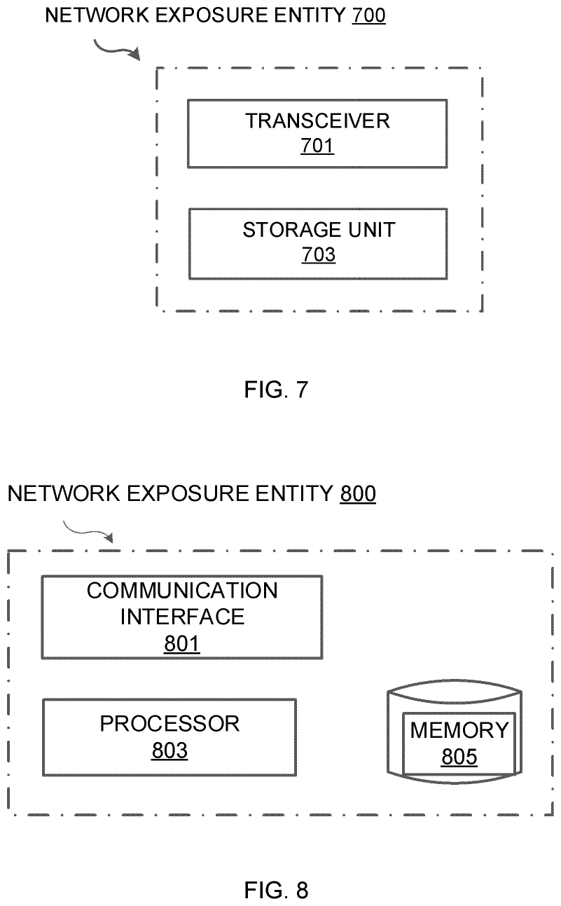

Hereinafter, a structure of a network exposure entity will be described with reference to FIG. 7. FIG. 7 illustratively shows a schematic structure diagram of a network exposure entity 700 (such as SCEF or NEF, e.g. SCEF/NEF 403 as shown in FIG. 4, as described previously) according to an exemplary embodiment of the present disclosure. The network exposure entity 700 in FIG. 7 may perform the method 200 for group-based data delivery configuration described previously with reference to FIG. 2. Accordingly, some detailed description on the network entity 700 for group-based data delivery configuration may refer to the corresponding description of the method 200 as previously discussed.

As shown in FIG. 7, the network exposure entity 700 may include a transceiver 701 and a storage unit 703. As will be understood by the skilled in the art, common components in the network exposure entity 700 are omitted in FIG. 7 for not obscuring the idea of the present disclosure.

The transceiver 701 of the network exposure entity 700 may be configured to receive, from a first network entity, such as SCS/AS (e.g. SCS/AS 401 as shown in FIG. 4), a predefined external group ID which identifies a group of UEs to which data are to be delivered by the first network entity in Step S201. The transceiver 701 of the network exposure entity 700 may also be configured to receive, from the first network entity, predefined configuration information which indicates a configuration to be applied for the group of UEs that enables a delivery of the data to the group of UEs.

The external group ID may be predefined in the first network entity and a second network entity, such as HSS (e.g. HSS 405 in FIG. 4), based on e.g. service agreements between the first network entity and the second network entity. Grouping of the UEs may be performed based on e.g. traffic characteristics, requirements etc., so that the UEs, e.g. CloT devices, such as sensors, cameras, having the same characteristics can be grouped in one group.

The configuration information may also be predefined in the first network entity and the second network entity, based on e.g. the service agreements between the first network entity and the second network entity.

The external group ID and the configuration information may be received in a data delivery configuration request message which is sent from the first network entity to the network exposure entity 700.

In an embodiment, the data may be non-IP data, and the data delivery configuration request message may be a NIDD Configuration Request message sent from the first network entity to the network exposure entity 700 (e.g. NIDD Configuration Request from SCS/AS 401 to SCEF/NEF 403 in Process 1 of FIG. 4).

The transceiver 701 of the network exposure entity 700 may further be configured to transmit, in Step S203, the external group ID to a second network entity, such as HSS (e.g. HSS 405 as shown in FIG. 4).

The storage unit 703 may be configured to store the configuration information indicating the configuration to be applied for the group of UEs that enables the delivery of the data to the group of UEs, so as to associate the configuration information with the external group ID and use it for further MT NIDD delivery.

The external group ID may be transmitted in a data delivery authorization request message which is sent from the network exposure entity 700 to the second network entity.

In an embodiment, the data may be non-IP data, and the data delivery authorization request message may be a NIDD Authorization Request message sent from the network exposure entity 700 to the second network entity (e.g. NIDD Authorization Request from SCEF/NEF 403 to HSS 405 in Process 3 of FIG. 4).

The transceiver 701 of the network exposure entity 700 may further be configured to receive, in Step S205, the information on IDs of respective UEs in the group from the second network entity.

In an embodiment, the information on IDs of respective UEs in the group may be received in a data delivery authorization response message which is sent from the second network entity to the network exposure entity 700.

In an embodiment, the data may be non-IP data, and the data delivery authorization response message is a NIDD Authorization Response message sent from the second network entity to the network exposure entity 700 (e.g. NIDD Authorization Response from HSS 405 to SCEF/NEF 403 in Process 5 of FIG. 4).

In an embodiment, the information on IDs of respective UEs in the group may include:
a list of IMSIs and a list of MSISDNs of the respective UEs in the group; or
a list of IMSIs and a list of external IDs of the respective UEs in the group.

The external IDs in the list of external IDs may be mapped from the external group ID by the second network entity. The list of IMSIs and the list of MSISDNs may be respectively mapped from the external IDs by the second network entity.

Then in Step S207, the storage unit 703 of the network exposure entity 700 may be configured to store the information on IDs of respective UEs in the group. Such information may be used for group-based delivery of data received from the first network entity to the respective UEs in the group.

The transceiver 701 of the network exposure entity 700 may further be configured to transmit a data delivery configuration response message to the first network entity.

In an embodiment, the data may be non-IP data, and the data delivery configuration request message may be a NIDD Configuration Response message sent from the first network entity to the network exposure entity 700 (e.g. NIDD Configuration Response from SCEF/NEF 403 to SCS/AS 401 in Process 6 of FIG. 4).

When there are data to be delivered from the network exposure entity 700 to the respective UEs in the group, the transceiver 701 of the network exposure entity 700 may also be configured to transmit, for each of the respective UEs in the group, the data received from the first network entity, based on the stored information (e.g. in Process 7 in FIG. 4) in Step S209.

In an embodiment, the data may be received by the network exposure entity 700 from the first network entity in a data delivery configuration request message (e.g., NIDD Configuration Request from SCS/AS 401 to SCEF/NEF 403 in Process 1 of FIG. 4). In this case, the network exposure entity may transmit the data to the respective UEs in the group, only after a PDN connection to the network exposure entity is established as defined in clause 5.13.1.2 of 3GPP TS 23.682.

Hereinafter, another structure of a network exposure entity will be described with reference to FIG. 8. FIG. 8 illustratively shows a schematic structure diagram of a network exposure entity 800 (referring to SCEF or NEF, e.g. SCEF/NEF 403 as shown in FIG. 4, as described previously) according to an exemplary embodiment of the present disclosure. The network exposure entity 800 in FIG. 8 may perform the method 200 for group-based data delivery configuration described previously with reference to FIG. 2. Accordingly, some detailed description on the network exposure entity 800 may refer to the corresponding description of the method 200 for group-based data delivery configuration as previously discussed.

As shown in FIG. 8, the network exposure entity 800 may include at least one controller or processor 803 including e.g., any suitable Central Processing Unit, CPU, microcontroller, Digital Signal Processor, DSP, etc., capable of executing computer program instructions. The computer program instructions may be stored in a memory 805. The memory 805 may be any combination of a RAM (Random Access Memory) and a ROM (Read Only Memory). The memory may also comprise persistent storage, which, for example, can be any single one or combination of magnetic memory, optical memory, or solid state memory or even remotely mounted memory. The exemplary network exposure entity 800 further comprises a communication interface 801 arranged for communication.

The instructions, when loaded from the memory 805 and executed by the at least one processor 803, may cause the network exposure entity 800 to perform the method 200 as previously described.

In particular, the instructions, when loaded from the memory 805 and executed by the at least one processor 803, may cause the network exposure entity 800 to receive, from a first network entity, such as SCS/AS (e.g. SCS/AS 401 as shown in FIG. 4), a predefined external group ID which identifies a group of UEs to which data are to be delivered by the first network entity and predefined configuration information which indicates a configuration to be applied for the group of UEs that enables a delivery of the data to the group of UEs via the communication interface 801 in Step S201.

The external group ID may be predefined in the first network entity and a second network entity, such as HSS (e.g. HSS 405 in FIG. 4), based on e.g. service agreements between the first network entity and the second network entity. Grouping of the UEs may be performed based on e.g. traffic characteristics, requirements etc., so that the UEs, e.g. CloT devices, such as sensors, cameras, having the same characteristics can be grouped in one group.

The configuration information may also be predefined in the first network entity and the second network entity, based on e.g. the service agreements between the first network entity and the second network entity.

The external group ID and the configuration information may be received in a data delivery configuration request message which is sent from the first network entity to the network exposure entity 800.

In an embodiment, the data may be non-IP data, and the data delivery configuration request message may be a NIDD Configuration Request message sent from the first network entity to the network exposure entity 800 (e.g. NIDD Configuration Request from SCS/AS 401 to SCEF/NEF 403 in Process 1 of FIG. 4).

The instructions, when loaded from the memory 805 and executed by the at least one processor 803, may cause the network exposure entity 800 to store the configuration information indicating the configuration to be applied for the group of UEs that enables the delivery of the data to the group of UEs, so as to associate the configuration information with the external group ID and use it for further MT NIDD delivery.

The instructions, when loaded from the memory 805 and executed by the at least one processor 803, may cause the network exposure entity 800 to transmit, in Step S203, the external group ID to a second network entity, such as HSS (e.g. HSS 405 as shown in FIG. 4) via the communication interface 801.

The external group ID may be transmitted in a data delivery authorization request message which is sent from the network exposure entity 800 to the second network entity.

In an embodiment, the data may be non-IP data, and the data delivery authorization request message may be a NIDD Authorization Request message sent from the network exposure entity 800 to the second network entity (e.g. NIDD Authorization Request from SCEF/NEF 403 to HSS 405 in Process 3 of FIG. 4).

Further, the instructions, when loaded from the memory 805 and executed by the at least one processor 803, may cause the network exposure entity 800 to receive, in Step S205, the information on IDs of respective UEs in the group from the second network entity via the communication interface 801.

In an embodiment, the information on IDs of respective UEs in the group may be received in a data delivery authorization response message which is sent from the second network entity to the network exposure entity 800.

In an embodiment, the data may be non-IP data, and the data delivery authorization response message is a NIDD Authorization Response message sent from the second network entity to the network exposure entity 800 (e.g. NIDD Authorization Response from HSS 405 to SCEF/NEF 403 in Process 5 of FIG. 4).

In an embodiment, the information on IDs of respective UEs in the group may include:
a list of IMSIs and a list of MSISDNs of the respective UEs in the group; or
a list of IMSIs and a list of external IDs of the respective UEs in the group.

The external IDs in the list of external IDs may be mapped from the external group ID by the second network entity. The list of IMSIs and the list of MSISDNs may be respectively mapped from the external IDs by the second network entity.

The instructions, when loaded from the memory 805 and executed by the at least one processor 803, may cause the network exposure entity 800 to store, in Step S207, the information on IDs of respective UEs in the group. Such information may be used for group-based delivery of data received from the first network entity to the respective UEs in the group.

The instructions, when loaded from the memory 805 and executed by the at least one processor 803, may cause the network exposure entity 800 to transmit a data delivery configuration response message to the first network entity.

In an embodiment, the data may be non-IP data, and the data delivery configuration request message may be a NIDD Configuration Response message sent from the first network entity to the network exposure entity 800 (e.g. NIDD Configuration Response from SCEF/NEF 403 to SCS/AS 401 in Process 6 of FIG. 4).

When there are data to be delivered from the network exposure entity 800 to the respective UEs in the group, the instructions may cause the network exposure entity 800 to transmit, for each of the respective UEs in the group, the data received from the first network entity, based on the stored information (e.g. in Process 7 in FIG. 4) in Step S209 via the communication interface 801.

In an embodiment, the data may be received by the network exposure entity 800 from the first network entity in a data delivery configuration request message (e.g., NIDD Configuration Request from SCS/AS 401 to SCEF/NEF 403 in Process 1 of FIG. 4). In this case, the network exposure entity 800 may transmit the data to the respective UEs in the group, only after a PDN connection to the network exposure entity 800 is established as defined in clause 5.13.1.2 of 3GPP TS 23.682.

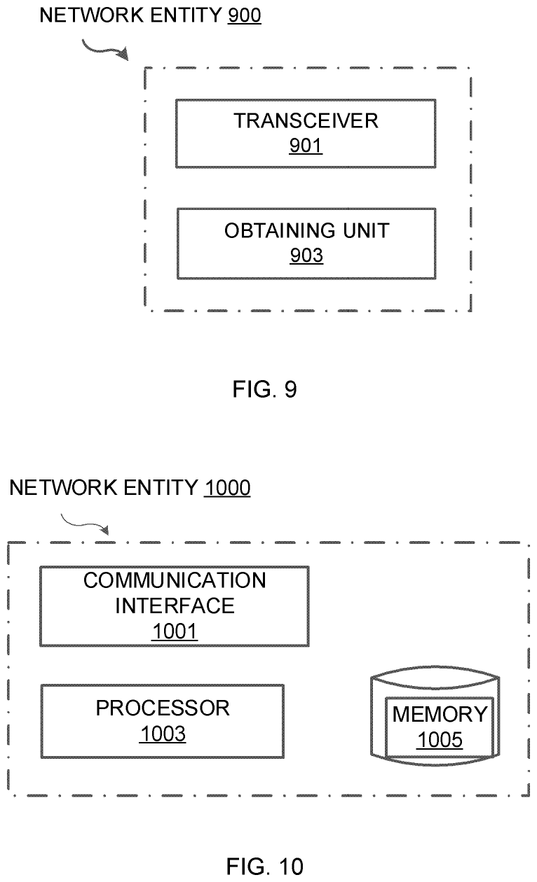

Hereinafter, a structure of a second network entity will be described with reference to FIG. 9. FIG. 9 illustratively shows a schematic structure diagram of a network entity 900 (referring to the second network entity, such as HSS, e.g. HSS 405 as shown in FIG. 4, as described previously) according to an exemplary embodiment of the present disclosure. The network entity 900 in FIG. 9 may perform the method 300 for group-based data delivery configuration described previously with reference to FIG. 3. Accordingly, some detailed description on the network entity 900 may refer to the corresponding description of the method 300 for group-based data delivery configuration as previously discussed.

As shown in FIG. 9, the network entity 900 may include a transceiver 901 and an obtaining unit 903. As will be understood by the skilled in the art, common components in the network entity 900 are omitted in FIG. 9 for not obscuring the idea of the present disclosure.

The transceiver 901 of the network entity 900 may be configured to receive, from a network exposure entity, such as SCEF or NEF (e.g. SCEF/NEF 403 as shown in FIG. 4), a predefined external group ID which identifies a group of UEs to which data are to be delivered in Step S301.

As previously described, the external group ID may be predefined in the first network entity, such as SCS/AS (e.g. SCS/AS 401 in FIG. 4) and a second network entity, based on e.g. service agreements between the first network entity and the second network entity. Grouping of the UEs may be performed based on e.g. traffic characteristics, requirements etc., so that the UEs, e.g. CloT devices, such as sensors, cameras, having the same characteristics can be grouped in one group.

The external group ID may be received in a data delivery authorization request message which is sent from the network exposure entity to the network entity 900.

In an embodiment, the data may be non-IP data, and the data delivery authorization request message may be a NIDD Authorization Request message sent from the network exposure entity to the network entity 900 (e.g. NIDD Authorization Request from SCEF/NEF 403 to HSS 405 in Process 3 of FIG. 4).

Then, the obtaining unit 903 of the network entity 900 may obtain, in Step S303, information on IDs of respective UEs in the group based on the external group ID (e.g. in Process 4 of FIG. 4).

In an embodiment, the obtaining unit 903 of the network entity 900 may further include an examination unit and a mapping unit (not shown). The examination unit is configured to examine the received data delivery authorization request message, e.g., with regard to existence of the external group ID; and the mapping unit is configured to map the external group ID to a list of external IDs of respective UEs in the group, e.g. according to its knowledge on correspondence between the external group ID and list of external IDs of respective UEs in the group predefined and stored in its database, and map the external IDs in the list of external IDs respectively to a list of IMSIs and a list of MSISDNs of the respective UEs in the group.

Thus, the information on IDs of respective UEs in the group may include:
the list of IMSIs and the list of MSISDNs of the respective UEs in the group; or
the list of IMSIs and the list of external IDs of the respective UEs in the group.

The transceiver 901 of the network entity 900 may further be configured to transmit, in Step S305, the information on IDs of respective UEs in the group to the network exposure entity.

The information on IDs of respective UEs in the group may be transmitted in a data delivery authorization response message which is sent from the network entity 900 to the network exposure entity.

In an embodiment, the data may be non-IP data, and the data delivery authorization response message is a NIDD Authorization Response message sent from the network entity 900 to the network exposure entity (e.g. NIDD Authorization Response from HSS 405 to SCEF/NEF 403 in Process 5 of FIG. 4).

Hereinafter, another structure of a second network entity will be described with reference to FIG. 10. FIG. 10 illustratively shows a schematic structure diagram of a network entity 1000 (referring to the second network entity, such as HSS, e.g. HSS 405 as shown in FIG. 4, as described previously) according to an exemplary embodiment of the present disclosure. The network entity 1000 in FIG. 10 may perform the method 300 for group-based data delivery configuration described previously with reference to FIG. 3. Accordingly, some detailed description on the network entity 1000 may refer to the corresponding description of the method 300 for group-based data delivery configuration as previously discussed.

As shown in FIG. 10, the network entity 1000 may include at least one controller or processor 1003 including e.g., any suitable Central Processing Unit, CPU, microcontroller, Digital Signal Processor, DSP, etc., capable of executing computer program instructions. The computer program instructions may be stored in a memory 1005. The memory 1005 may be any combination of a RAM (Random Access Memory) and a ROM (Read Only Memory). The memory may also comprise persistent storage, which, for example, can be any single one or combination of magnetic memory, optical memory, or solid state memory or even remotely mounted memory. The exemplary network entity 1000 further comprises a communication interface 1001 arranged for communication.

The instructions, when loaded from the memory 1005 and executed by the at least one processor 1003, may cause the network entity 1000 to perform the method 300 as previously described.

In particular, the instructions, when loaded from the memory 1005 and executed by the at least one processor 1003, may cause the network entity 1000 to receive, via the communication interface 1001 from a network exposure entity, such as SCEF or NEF (e.g. SCEF/NEF 403 as shown in FIG. 4), a predefined external group ID which identifies a group of UEs to which data are to be delivered in Step S301.

As previously described, the external group ID may be predefined in the first network entity, such as SCS/AS (e.g. SCS/AS 401 in FIG. 4) and a second network entity, based on e.g. service agreements between the first network entity and the second network entity. Grouping of the UEs may be performed based on e.g. traffic characteristics, requirements etc., so that the UEs, e.g. CloT devices, such as sensors, cameras, having the same characteristics can be grouped in one group.

The external group ID may be received in a data delivery authorization request message which is sent from the network exposure entity to the network entity 1000.

In an embodiment, the data may be non-IP data, and the data delivery authorization request message may be a NIDD Authorization Request message sent from the network exposure entity to the network entity 1000 (e.g. NIDD Authorization Request from SCEF/NEF 403 to HSS 405 in Process 3 of FIG. 4).

The instructions, when loaded from the memory 1005 and executed by the at least one processor 1003, may cause the network entity 1000 to obtain, in Step S303, information on IDs of respective UEs in the group based on the external group ID (e.g. in Process 4 of FIG. 4).

In an embodiment, the instructions, when loaded from the memory 1005 and executed by the at least one processor 1003, may cause the network entity 1000 to examine the received data delivery authorization request message, e.g., with regard to existence of the external group ID; and map the external group ID to a list of external IDs of respective UEs in the group, e.g. according to its knowledge on correspondence between the external group ID and list of external IDs of respective UEs in the group predefined and stored in its database, and map the external IDs in the list of external IDs respectively to a list of IMSIs and a list of MSISDNs of the respective UEs in the group.

Thus, the information on IDs of respective UEs in the group may include:
the list of IMSIs and the list of MSISDNs of the respective UEs in the group; or
the list of IMSIs and the list of external IDs of the respective UEs in the group.

The instructions, when loaded from the memory 1005 and executed by the at least one processor 1003, may cause the network entity 1000 to transmit, in Step S305, the information on IDs of respective UEs in the group to the network exposure entity via the communication interface 1001.

The information on IDs of respective UEs in the group may be transmitted in a data delivery authorization response message which is sent from the network entity 1000 to the network exposure entity.

In an embodiment, the data may be non-IP data, and the data delivery authorization response message is a NIDD Authorization Response message sent from the network entity 1000 to the network exposure entity (e.g. NIDD Authorization Response from HSS 405 to SCEF/NEF 403 in Process 5 of FIG. 4).

The foregoing description of implementations provides illustration and description, but is not intended to be exhaustive or to limit the disclosure to the precise form disclosed. Modifications and variations are possible in light of the above teachings, or may be acquired from practice of the disclosure.

Aspects of the disclosure may also be embodied as methods and/or computer program products. Accordingly, the disclosure may be embodied in hardware and/or in hardware/software (including firmware, resident software, microcode, etc.). Furthermore, the embodiments may take the form of a computer program product on a computer-usable or computer-readable storage medium having computer-usable or computer-readable program code embodied in the medium for use by or in connection with an instruction execution system. Such instruction execution system may be implemented in a standalone or distributed manner. The actual software code or specialized control hardware used to implement embodiments described herein is not limiting of the disclosure. Thus, the operation and behavior of the aspects were described without reference to the specific software code, it being understood that those skilled in the art will be able to design software and control hardware to implement the aspects based on the description herein.

Furthermore, certain portions of the disclosure may be implemented as “logic” that performs one or more functions. This logic may include hardware, such as an application specific integrated circuit or field programmable gate array or a combination of hardware and software.

It should be emphasized that the term “comprises/comprising” when used in this specification is taken to specify the presence of stated features, integers, steps, components or groups but does not preclude the presence or addition of one or more other features, integers, steps, components or groups thereof.

No element, act, or instruction used in the disclosure should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The foregoing description gives only the embodiments of the present disclosure and is not intended to limit the present disclosure in any way. Thus, any modification, substitution, improvement or like made within the spirit and principle of the present disclosure should be encompassed by the scope of the present disclosure.

1-43. (canceled)

44. A method, in a network exposure entity, for data delivery configuration, the method comprising the network exposure entity:
receiving, from a network entity and in a Non-IP Data Delivery (NIDD) configuration request message, a predefined external group ID which identifies a group of user equipments (UEs) to which Non IP data are to be delivered by the network entity and predefined configuration information which indicates a configuration to be applied for the group of UEs that enables a delivery of the data to the group of UEs;
transmitting the external group ID to another network entity in a NIDD Authorization Request message; and
receiving information on IDs of respective UEs in the group of UEs from the other network entity in a data delivery authorization response message.

45. The method of claim 44, further comprising: storing the configuration information.

46. The method of claim 44, further comprising:
receiving, from the other network entity, information on IDs of respective UEs in the group; and
storing the information which can be used for group-based delivery of data received from the network entity to the respective UEs in the group.

47. The method of claim 46, further comprising transmitting, for each of the respective UEs in the group, the data received from the network entity, based on the stored information.

48. The method of claim 47, wherein the data is received from the network entity in a data delivery configuration request message.

49. The method of claim 46, wherein the information comprises:
a list of International Mobile Subscriber Identifications (IMSIs) and a list of Mobile Station Integrated Services Digital Network Numbers (MSISDNs) of the respective UEs in the group; or
a list of IMSIs and a list of external IDs of the respective UEs in the group.

50. The method of claim 49, wherein the external IDs in the list of external IDs are mapped from the external group ID; and wherein the list of IMSIs and the list of MSISDNs are respectively mapped from the external IDs by the other network entity.

51. The method of claim 44, wherein:
the network exposure entity is a Service Capability Exposure Function (SCEF) entity or a Network Exposure Function (NEF) entity;
the network entity is a third party Services Capability Server/Application Server (SCS/AS); and
the other network entity is a Home Subscriber Server (HSS).

52. A method, in a network entity, for data delivery configuration, the method comprising the network entity:
receiving, from a network exposure entity and in a Non IP data (NIDD) Authorization Request message, a predefined external group ID which identifies a group of user equipments (UEs) to which Non IP data is to be delivered; and
obtaining information on IDs of respective UEs in the group of UEs based on the external group ID.

53. The method of claim 52, further comprising transmitting the information on IDs of respective UEs in the group to the network exposure entity in a NIDD Authorization Response message.

54. The method of claim 52, wherein the obtaining the information on IDs of respective UEs in the group based on the external group ID comprises:
mapping the external group ID to a list of external IDs of respective UEs in the group; and
mapping the external IDs in the list of external IDs respectively to a list of International Mobile Subscriber Identifications (IMSIs) and a list of Mobile Station Integrated Services Digital Network Numbers (MSISDNs) of the respective UEs in the group.

55. The method of claim 54, wherein the information comprises:
the list of IMSIs and the list of MSISDNs of the respective UEs in the group; or
the list of IMSIs and the list of external IDs of the respective UEs in the group.

56. The method of claim 52, wherein:
the network entity is a Home Subscriber Server (HSS); and
the network exposure entity is a Service Capability Exposure Function (SCEF) entity or a Network Exposure Function (NEF) entity.

57. A network exposure entity, comprising:
a communication interface configured for communication;
processing circuitry;
memory containing instructions executable by the processing circuitry whereby the network exposure entity is operative to:
receive, from the a network entity and via the communication interface, a predefined external group ID which identifies a group of user equipments (UEs) to which data are to be delivered by the network entity and predefined configuration information which indicates a configuration to be applied for the group of UEs that enables a delivery of the data to the group of UEs; and
transmit, via the communication interface, the external group ID to another network entity.

58. The network exposure entity of claim 57, wherein the instructions are such that the network exposure entity is operative to store the configuration information indicating the configuration to be applied for the group of UEs that enables the delivery of the data to the group of UEs.

59. The network exposure entity of claim 57, wherein the instructions are such that the network exposure entity is operative to:
receive, via the communication interface and from the another network entity, information on IDs of respective UEs in the group; and
store the information which can be used for group-based delivery of data received from the network entity to the respective UEs in the group.

60. The network exposure entity of claim 58, wherein the instructions are such that the network exposure entity is operative to transmit, via the communication interface and for each of the respective UEs in the group, the data received from the network entity.

61. The network exposure entity of claim 59, wherein the data is received from the network entity in a data delivery configuration request message.

62. The network exposure entity of claim 59, wherein the information comprises:
a list of International Mobile Subscriber Identifications (IMSIs) and a list of Mobile Station Integrated Services Digital Network Numbers (MSISDNs) of the respective UEs in the group; or
a list of IMSIs and a list of external IDs of the respective UEs in the group.

63. The network exposure entity of claim 62:
wherein the external IDs in the list of external IDs are mapped from the external group ID; and
wherein the list of IMSIs and the list of MSISDNs are respectively mapped from the external IDs by the another network entity.

64. The network exposure entity of claim 57, wherein:
the network exposure entity is a Service Capability Exposure Function (SCEF) entity or a Network Exposure Function (NEF) entity;
the network entity is a third party Services Capability Server/Application Server (SCS/AS); and
the another network entity is a Home Subscriber Server (HSS).

65. A network entity, comprising:
a communication interface configured for communication;
processing circuitry;
memory containing instructions executable by the processing circuitry whereby the network entity is operative to:
receive, from a network exposure entity and via the communication interface, a predefined external group ID which identifies a group of user equipments (UEs) to which data is to be delivered; and
obtaining information on IDs of respective UEs in the group based on the external group ID.

66. The network entity of claim 65, wherein the instructions are such that the network entity is operative to transmit the information on IDs of respective UEs in the group to the network exposure entity.

67. The network entity of claim 65, wherein the instructions are such that the network entity is operative to obtain the information on IDs of respective UEs in the group based on the external group ID by:
mapping the external group ID to a list of external IDs of respective UEs in the group; and
mapping the external IDs in the list of external IDs respectively to a list of International Mobile Subscriber Identifications (IMSIs) and a list of Mobile Station Integrated Services Digital Network Numbers (MSISDNs) of the respective UEs in the group.

68. The network entity of claim 67, wherein the information comprises:
the list of IMSIs and the list of MSISDNs of the respective UEs in the group; or
the list of IMSIs and the list of external IDs of the respective UEs in the group.

69. The network entity of claim 65, wherein:
the network entity is a Home Subscriber Server (HSS); and
the network exposure entity is a Service Capability Exposure Function (SCEF) entity or a Network Exposure Function (NEF) entity.
